(19) United States
(12) Patent Application Publication
(10) Pub. No.: US 2018/0021793 A1
(43) Pub. Date: Jan. 25, 2018

(54) DIRECTIONAL COLD SPRAY METHOD

(71) Applicant: Moog Inc., East Aurora, NY (US)

(72) Inventors: Benjamin HOILAND, Thompson, ND (US); Jarrod SCHELL, Emerado, ND (US); Christopher HOWE, Worcester, MA (US)

(21) Appl. No.: 15/720,465

(22) Filed: Sep. 29, 2017

Related U.S. Application Data
(62) Division of application No. 14/747,624, filed on Jun. 23, 2015.

(51) Int. Cl. B05B 7/14; C23C 24/04

(52) U.S. Cl. CPC B05B 7/1486; C23C 24/04; B33Y 80/00

(57) ABSTRACT

A directional cold spray nozzle defines a flow passageway that includes a bend for redirecting flow from a first flow direction to a second flow direction different from the first flow direction, wherein the flow passageway is divergent through at least a portion of the bend. The flow passageway may be convergent prior to becoming divergent in the path of flow. The directional cold spray nozzle simultaneously accelerates the powder and carrier gas and changes the spray direction of the spray plume to reach interior bore surfaces and other surfaces that are difficult or impossible to reach with a straight nozzle.

### FIELD OF THE INVENTION

The present invention relates generally to nozzles used in cold spray processes to apply material coatings workpiece surfaces.

### BACKGROUND OF THE INVENTION

Cold gas dynamic spraying, commonly referred to as cold spraying, is a technique whereby powdered metal is deposited on a surface through solid state bonding. The bonding is achieved by accelerating the particles of powdered metal to supersonic speeds through “de Laval” type nozzle having a converging and diverging passageway. A carrier gas, for example helium and/or nitrogen gas, is used to carry the particles through the nozzle passageway. Cold spraying may be used to apply abrasion and/or corrosion resistant coatings to metal parts, and to repair structurally damaged metal parts. For example, aircraft maintenance and repair operations may utilize cold spraying techniques.

Straight converging and diverging nozzles are well known in the cold spraying art, as demonstrated by U.S. Pat. Nos. 7,543,764 and 8,784,584. While straight nozzles are effective for depositing material on external surfaces of an object, they are often poorly suited for depositing material on internal surfaces where space is restricted, for example an internal wall surface of a bore.

A directional cold spray nozzle is known from U.S. Pat. No. 7,959,093. The directional nozzle includes an upstream axial section 124 and a downstream radial section 126 connected to the axial section 124 by a bend 128. A converging and diverging portion 123 of the nozzle passageway is located entirely in the upstream axial section 124 of the nozzle. Once the passageway reaches bend 128, it is no longer diverging. Consequently, the carrier gas and particles experience deceleration through bend 128 and radial section 126, making it difficult to maintain critical velocity needed for solid state bonding. One embodiment shown at FIG. 3 of the ‘093 patent adds a series of gas jets 134 along bend 128 help maintain velocity. However, the provision of extra gas jets impedes the goal of allowing the nozzle to reach surfaces of confined internal spaces.

What is needed is a directional cold spray nozzle that accelerates the carrier gas and powder particles as flow direction changes, without reliance on space-consuming supplemental gas jets.

### SUMMARY OF THE INVENTION

According to one embodiment, the present invention is provides a directional cold spray nozzle that simultaneously accelerates the powder and carrier gas and changes the spray direction of the spray plume to reach interior bore surfaces and other surfaces that are difficult or impossible to reach with a straight nozzle. The directional cold spray nozzle defines a flow passageway that includes a bend for redirecting flow from a first flow direction to a second flow direction different from the first flow direction, wherein the flow passageway is divergent through at least a portion of the bend. The flow passageway may be convergent prior to becoming divergent in the path of flow.

In another embodiment, the directional cold spray nozzle comprises a base adapted for mounting the nozzle on a cold spray system. The base may be removable from the nozzle for exchange with a different base. The flow passageway may be convergent within the base.

The invention may also be embodied as a cold spray system that comprises the nozzle summarized above.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic representation of a cold spray system employing a directional nozzle in accordance with an embodiment of the present invention;

FIG. 2 is a perspective view of the directional cold spray nozzle represented in FIG. 1;

FIG. 3 is an enlarged cross-sectional view of the directional cold spray nozzle represented in FIG. 1;

FIG. 4 is a schematic representation of an alternative cold spray system employing a directional nozzle in accordance with another embodiment of the present invention;

FIG. 5 is a perspective view of the directional cold spray nozzle represented in FIG. 4; and

FIG. 6 is an enlarged cross-sectional view of the directional cold spray nozzle represented in FIG. 4.

### DETAILED DESCRIPTION OF THE INVENTION

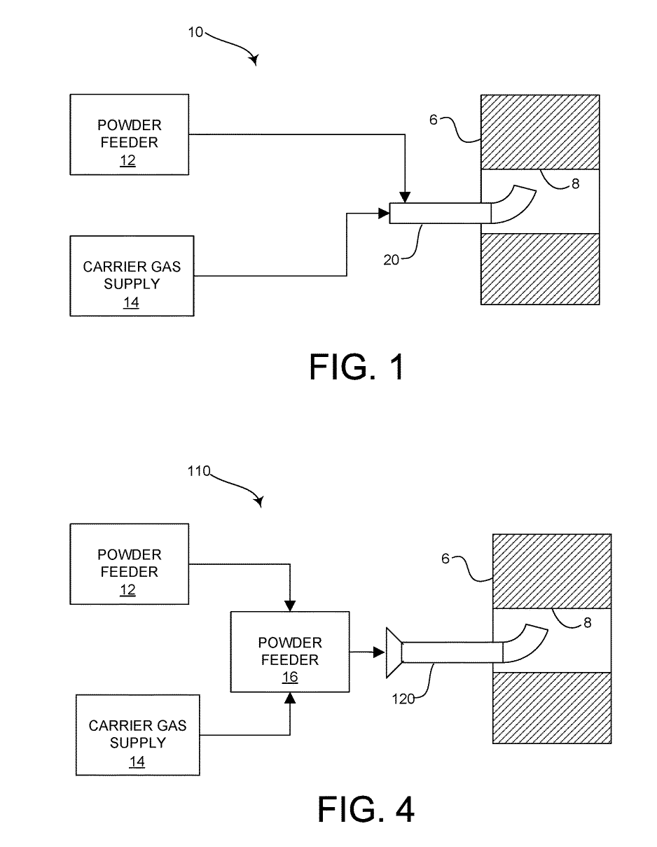

FIG. 1 schematically depicts a cold spray system 10 embodying the present invention. Cold spray system 10 may be used for applying material to a workpiece 6 to manufacture or repair the workpiece. For example, cold spray system 10 may be used to apply a protective coating on surfaces of workpiece 6 or add filler material into cracks or recesses in workpiece 6. Cold spray system 10 includes a directional nozzle 20 intended to reach surfaces of workpiece 6 that are not readily accessible with a straight nozzle, for example an inner wall surface 8 of a hole or bore. Cold spray system 10 is conventional to the extent it includes a powder feeder 12 and a carrier gas supply 14. Powder feeder 12 injects powder directly into nozzle 20 through one or more injection ports (not shown in FIG. 1) so the powder mixes with a carrier gas stream delivered to an entry end of nozzle 20 by carrier gas supply 14. Alternatively, system 10 may be configured with a mixing chamber (not shown in FIG. 1) upstream from nozzle 20 that receives powder material from powder feeder 12 and carrier gas from carrier gas supply 14 and delivers a mixture of the powder material and carrier gas as a pressurized flow to the entry end of nozzle 20. As may be understood, nozzle 20 is configured to change the flow direction of the mixture to allow application to surfaces of workpiece 6 that may be difficult or impossible to reach with a straight nozzle, for example internal wall surface 8.

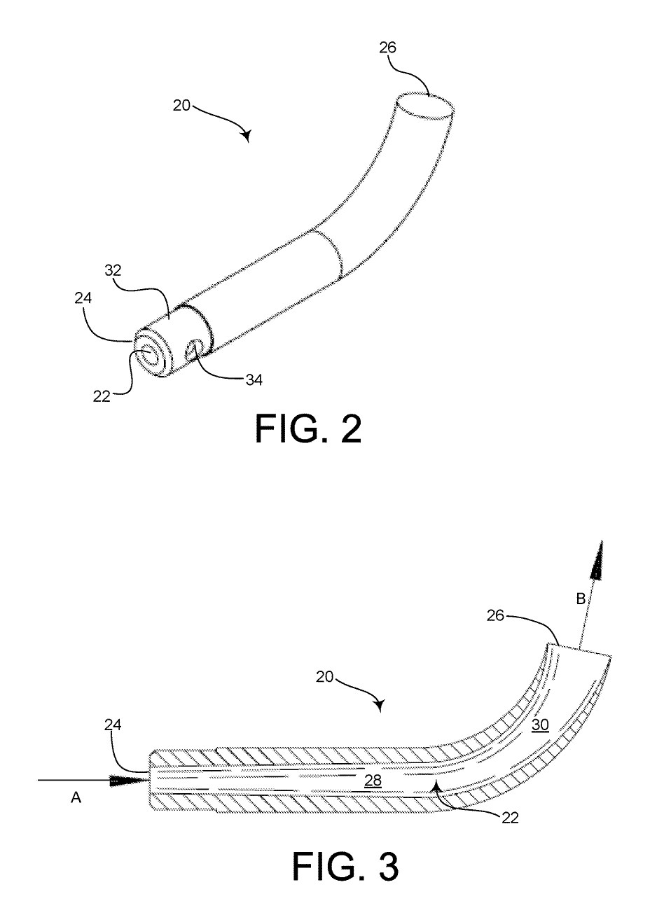

FIGS. 2 and 3 show directional cold spray nozzle 20 in greater detail. Nozzle 20 defines a flow passageway 22 extending from an upstream entry end 24 of nozzle 20 through which the gas/powder mixture enters nozzle 20 to a downstream exit end 26 of the nozzle through which the gas/powder mixture is discharged out of the nozzle. Flow passageway 22 includes a bend 30 for redirecting flow from a first flow direction A to a second flow direction B different from the first flow direction. In accordance with the present invention, flow passageway 22 is divergent through at least a portion of bend 30. In the context of the present application, the term “divergent” means that the cross-sectional area of the passageway increases in a continuous manner as flow progresses along a flow path defined by the passageway. In the depicted embodiment, passageway 22 is divergent through the entire bend 30, however it is also possible to configure passageway 22 to be divergent through only a portion of bend 30 without straying from the invention. Flow passageway 22 may include a straight portion 28 upstream from bend 30, and the flow passageway may be divergent within some or all of straight segment 28 and the flow passageway may be divergent as it transitions from straight segment 28 to bend 30.

In the embodiment shown in FIGS. 2 and 3, nozzle 20 includes a base 32 adjacent entry end 24 adapted for mounting the nozzle on a cold spray system. For example, base 32 may have threads and/or other features for connecting nozzle 20 to another structure. Nozzle 20 may include one or more injection ports 34 at base 32 for injection of powder material into flow passageway 22.

FIG. 4 shows another cold spray system 110 embodying the present invention. Cold spray system 110 includes a directional nozzle 120 intended to reach surfaces of workpiece 6 that are not readily accessible with a straight nozzle. Cold spray system 110 is conventional to the extent it includes a mixing chamber 16 in communication with a powder feeder 12 and a carrier gas supply 14. Powder material from powder feeder 12 and carrier gas from carrier gas supply 14 are mixed in mixing chamber 16 and the mixture is delivered as a pressurized flow to nozzle 120. Similar to nozzle 20 described above, nozzle 120 is configured to change the flow direction of the mixture to allow application to surfaces of workpiece 6 that may be difficult or impossible to reach using a straight nozzle, such as internal wall surface 8.

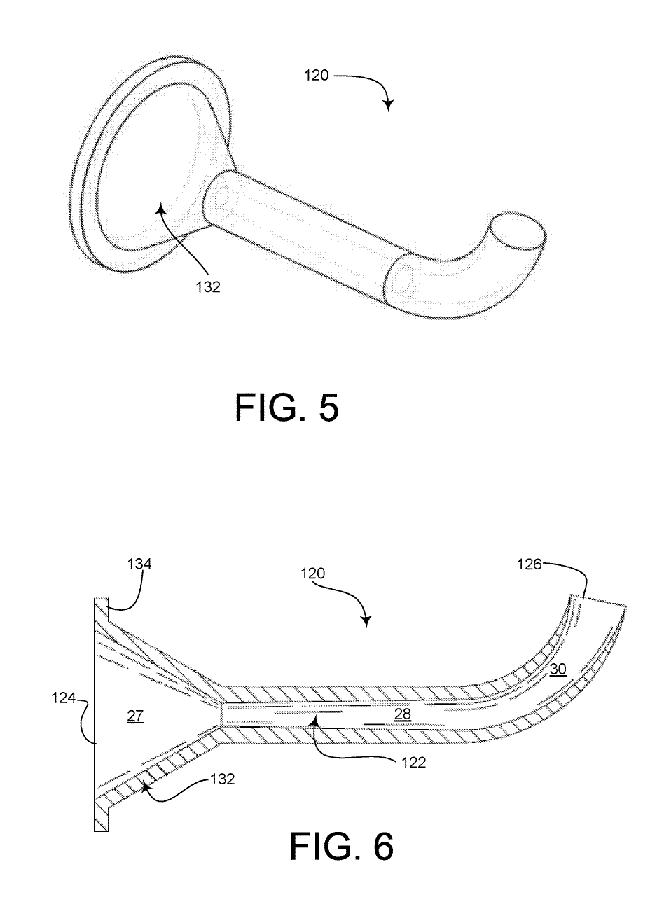

FIGS. 5 and 6 show directional nozzle 120 in further detail. Nozzle 120 defines a flow passageway 122 extending from an upstream entry end 124 of nozzle 120 to a downstream exit end 126 of the nozzle. Similar to flow passageway 22 of the previous embodiment, flow passageway 122 includes a bend 30 for redirecting flow from a first flow direction to a second flow direction different from the first flow direction, and flow passageway 122 is divergent through at least a portion of bend 30. Flow passageway 122 further includes a reduction region 27 adjacent to and upstream from straight segment 28. As may be seen in FIG. 6, flow passageway 122 is convergent through reduction region 27. In the context of the present application, the term “convergent” means that the cross-sectional area of the passageway decreases in a continuous manner as flow progresses along a flow path defined by the passageway. In nozzle 120, the flow passageway 122 is convergent prior to becoming divergent in the path of flow.

In the embodiment shown in FIGS. 5 and 6, nozzle 120 includes a base 132 adjacent entry end 124 adapted for mounting the nozzle on a cold spray system. For example, base 132 may have a mounting flange 134 for coupling nozzle 120 to another structure. As may be seen in FIG. 6, reduction region 27 in which passageway 122 is convergent may be defined within base 132. Base 132 may be made as a detachable component of nozzle 120, wherein base 132 can be decoupled from the remainder of the nozzle and replaced with another base having different mounting features and/or a differently configured reduction region 27. For example, base 132 may be threadably coupled with the remainder of nozzle 120 or removably attached to the remainder of nozzle 120 by fasteners or a clamping mechanism.

Additive manufacturing is suitable for manufacturing nozzles 20 and 120 in order to provide a passageway that diverges as it bends. For example, metallic or polymer 3D-printing techniques may be employed. Alternatively, nozzles 20 and 120 may be manufactured using traditional molding methods or mechanical forming methods. The geometric parameters of flow passageways 22, 122, including but not limited to the entry and exit diameters, length, and degree of bend or curvature, are subject to variation depending on requirements of the particular cold spray application and the desired spray velocity. Nozzle material may vary depending on chemical composition of the powder being sprayed. Examples of possibly suitable nozzle materials include tungsten carbide, polybenzimidazole, carbon composite, other polymers, and other metallics and non-metallics. A hybrid of different materials may be used (e.g. a metallic base or converging nozzle portion and a polymer diverging nozzle portion).

Nozzle 20 includes a powder injection port 34, however nozzle 120 does not include a powder injection port. If a powder injection port is provided, the injection port may be straight, angled or curved. An air or liquid cooling jacket (not shown) may be arranged around nozzle 20, 120 to dissipate heat.

As will be appreciated, nozzles 20, 120 of the present invention simultaneously accelerate the powder and change the spray direction of the spray plume. Nozzles 20, 120 will allow access to small diameter bores, e.g. bores that are less than three inches in diameter, and features that are difficult to reach with a straight nozzle.

While the invention has been described in connection with exemplary embodiments, the detailed description is not intended to limit the scope of the invention to the particular forms set forth. The invention is intended to cover such alternatives, modifications and equivalents of the described embodiment as may be included within the scope of the invention.

1.-13. (canceled)

14. A cold spray method of applying material to a workpiece, the method comprising the steps of:
accelerating a flow of powder and a carrier gas through a nozzle;
changing a direction of the flow as the carrier gas and the powder travel through the nozzle without introducing additional gas streams to the nozzle; and
discharging the flow from an exit end of the nozzle to a surface of the workpiece such that the powder adheres to the surface of the workpiece through solid state bonding;
wherein the steps of accelerating the flow and changing the direction of the flow occur simultaneously; and
wherein the surface of the workpiece is an interior surface of a hole having a diameter which is less than three inches.

15. The method according to claim 14, wherein the carrier gas is delivered to an entry end of the nozzle and the powder is injected into the nozzle through at least one injection port.

16. The method according to claim 14, wherein a mixture of the carrier gas and the powder is delivered to an entry end of the nozzle.
